(19) United States
(12) Patent Application Publication
(10) Pub. No.: US 2015/0130100 A1
(43) Pub. Date: May 14, 2015

(54) METHOD AND APPARATUS FOR LEVELING A THREE DIMENSIONAL PRINTING PLATFORM

(71) Applicant: John D. Fiegener, Marblehead, MA (US)

(72) Inventor: John D. Fiegener, Marblehead, MA (US)

(21) Appl. No.: 14/082,701

(22) Filed: Nov. 18, 2013

Related U.S. Application Data
(63) Continuation-in-part of application No. 14/077,677, filed on Nov. 12, 2013.

(51) Int. Cl. B29C 67/00

(52) U.S. Cl. CPC B29C 67/0092; B29C 67/0055; B33Y 10/00; B33Y 30/00
USPC 264/40.1; 425/150

(57) ABSTRACT

This invention relates to a method and apparatus for leveling a three dimensional printing platform. In one embodiment of the invention, the printer assembly is provided with a sensor for determining the distance between the sensor and the printing platform or plate. Inasmuch as printer assembly is movable about an X-Y plane above the plate, printer assembly may move to determine the distance between the sensor and printing plate at several different areas of the plate. A control system then calculates the relative adjustments necessary to move the corners of the plate to make the plate horizontally level. A set of four threaded rods with attached motors may be provided to move the associated four corners of the plate vertically to adjust the overall level of the plate.

### CROSS REFERENCE TO RELATED APPLICATION

This application is a continuation-in-part of U.S. patent application Ser. No. 14/077,677, filed Nov. 12, 2013; the disclosure of which is incorporated herein by reference.

### BACKGROUND OF THE INVENTION

1. Technical Field

This invention relates to a method and apparatus for leveling a three dimensional printing platform. More particularly, this invention relates to moving a printer assembly to examine multiple areas of the printing platform or plate for use in leveling the plate. Specifically, this invention relates to examining a printing platform and actuating one or more motors to turn threaded rods and move a follower connected to the printing platform to move and level the platform.

2. Background Information

Current three dimensional printers may use a printer assembly movable in the X-Y plane used in conjunction with a printing platform or plate. The plate is movable in the Z plane to make vertical adjustments during printing. However, plate must stay horizontally level at all times to ensure a proper printing of an object. Currently, three dimensional printers do not account for any wobble or tolerance slippage that may occur with the printing plate. This represents and enormous problem in the art, as much time and expenses are wasted when a printing plate becomes not level and needs manually adjusted and reconfigured. Thus, there is a need in the art to eliminate the problems associated with leveling printing plates in a three dimensional printing environment.

### BRIEF SUMMARY OF THE INVENTION

In one aspect, the invention may provide a method of three dimensional printing adapted to print a three dimensional object, the method comprising the steps of moving a printer assembly to a first area of a vertically adjustable plate; measuring a first height of the first area using the printer assembly; moving a printer assembly to a second area of the vertically adjustable plate; measuring a second height of the second area using the printer assembly; determining whether the plate is horizontally level by comparing the first height and the second height; leveling the plate if the plate is not horizontally level; and printing the three dimensional object onto the plate.

In another aspect, the invention may provide an apparatus adapted to print a three dimensional object, the apparatus comprising: a printer assembly movable in a plane; a sensor disposed on the printer assembly and movable therewith; a plate having a surface and movable between a level position and an unlevel position, wherein the surface is parallel with the plane when the plate is in the level position, and wherein the surface is not parallel with the plane when the plate is in the unlevel position; a control system, wherein the control system is adapted to move the printer assembly to print the three dimensional object, and wherein the control system is adapted to move the plate from the unlevel position to the level position; and wherein the sensor is configured to determine whether the plate is in the unlevel position and actuate the control system to move the plate to the level position when the plate is in the unlevel position.

In another aspect, the invention may provide a method a method of printing a three dimensional object, the method comprising the steps of: positioning a printer assembly over a first area of the plate; determining a first distance between a sensor disposed on the printer assembly and the first area; positioning the printer assembly over a second area of the plate; determining a second distance between the sensor and the second area; calculating a difference between the first distance and the second distance; determining whether the difference is within a threshold; determining an adjustment amount if the difference is not within the threshold; moving one of the first area and the second area vertically by the adjustment amount to level the plate if the difference is not within the threshold; receiving a plurality of pellets into a hopper of the printer assembly; melting the plurality of pellets in the printer assembly to form a printing filament; and expelling the printing filament onto the plate to form the three dimensional object.

### BRIEF DESCRIPTION OF THE SEVERAL VIEWS OF THE DRAWINGS

One or more preferred embodiments that illustrate the best mode(s) are set forth in the drawings and in the following description. The appended claims particularly and distinctly point out and set forth the invention.

The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a perspective view of a printer of the present invention;

FIG. 2 is a similar view thereof showing a hopper of the printer separated from a base of the printer;

FIG. 3 is a perspective view of an under side of the hopper;

FIG. 4 is a top view of the base having a top wall removed;

FIG. 5 is a cross-sectional view taken along line 4-4 of FIG. 3;

FIG. 6 is an enlarged view of a printer assembly of the present invention;

FIG. 7 is a cross-sectional view similar to FIG. 5 showing the printer assembly moved in the direction of Arrow B;

FIG. 8 is an enlarged cross-sectional view of the printer assembly and the hopper showing pellets moving from the hopper to the printer assembly;

FIG. 9 is a similar view thereof showing the pellets being melted and extruded by the printer assembly;

FIG. 10 is a similar view thereof showing another embodiment of the printer assembly;

FIG. 11 is a perspective view of another embodiment of the printer of the present invention;

FIG. 12 is a cross-sectional view taken along line 12-12 of FIG. 5;

FIG. 13 is a cross-sectional view taken along line 13-13 of FIG. 5;

FIG. 14 is an enlarged side view of the upper area of the threaded rod taken from FIG. 5;

FIG. 15 is an enlarged side view of the middle area of the threaded rod taken from FIG. 5;

FIG. 16 is an enlarged side view of the lower area of the threaded rod taken from FIG. 5;

FIG. 17 is an enlarged side view of an unlevel printing plate with the sensor of the printer assembly measuring the distance between the sensor and the plate on one side of the plate;

FIG. 18 is an enlarged side view of the unlevel printing plate with the sensor of the printer assembly measuring the distance between the sensor and the plate on a different side of the plate;

FIG. 19 is an enlarged side view of a level printing plate and the printer assembly;

FIG. 20 is a flow chart depicting a method of the present invention;

FIG. 21 is a flow chart depicting a method of the present invention;

FIG. 22 is a flow chart depicting a method of the present invention; and

FIG. 23 is a flow chart depicting a method of the present invention.

Similar numbers refer to similar parts throughout the drawings.

### DETAILED DESCRIPTION OF THE INVENTION

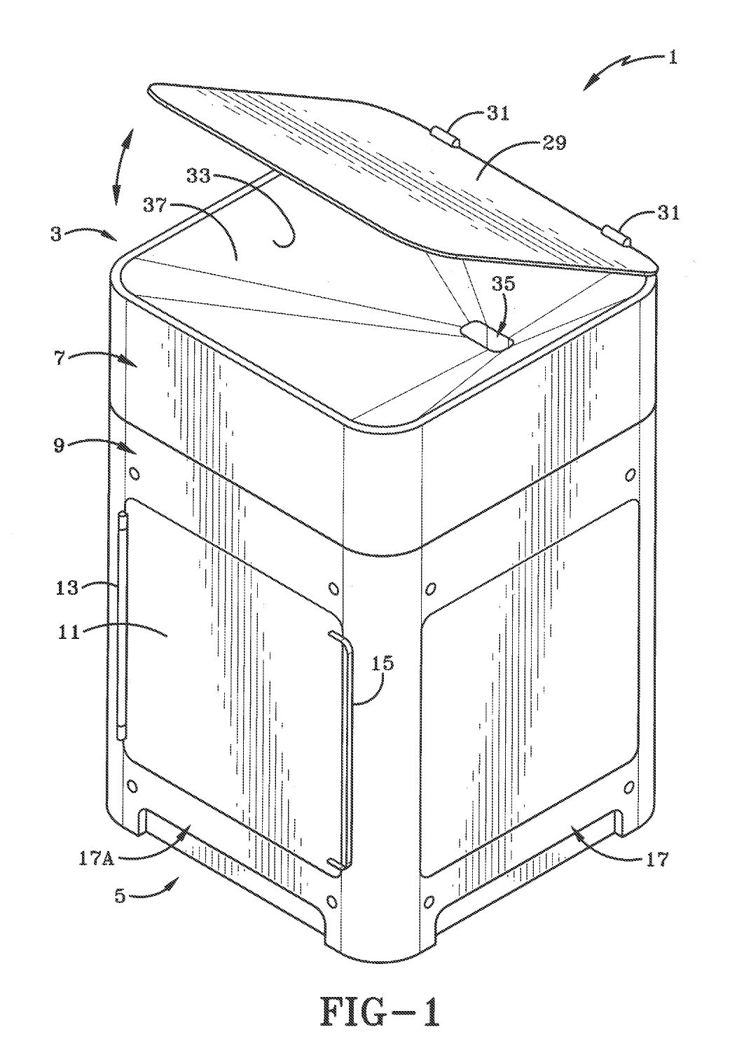

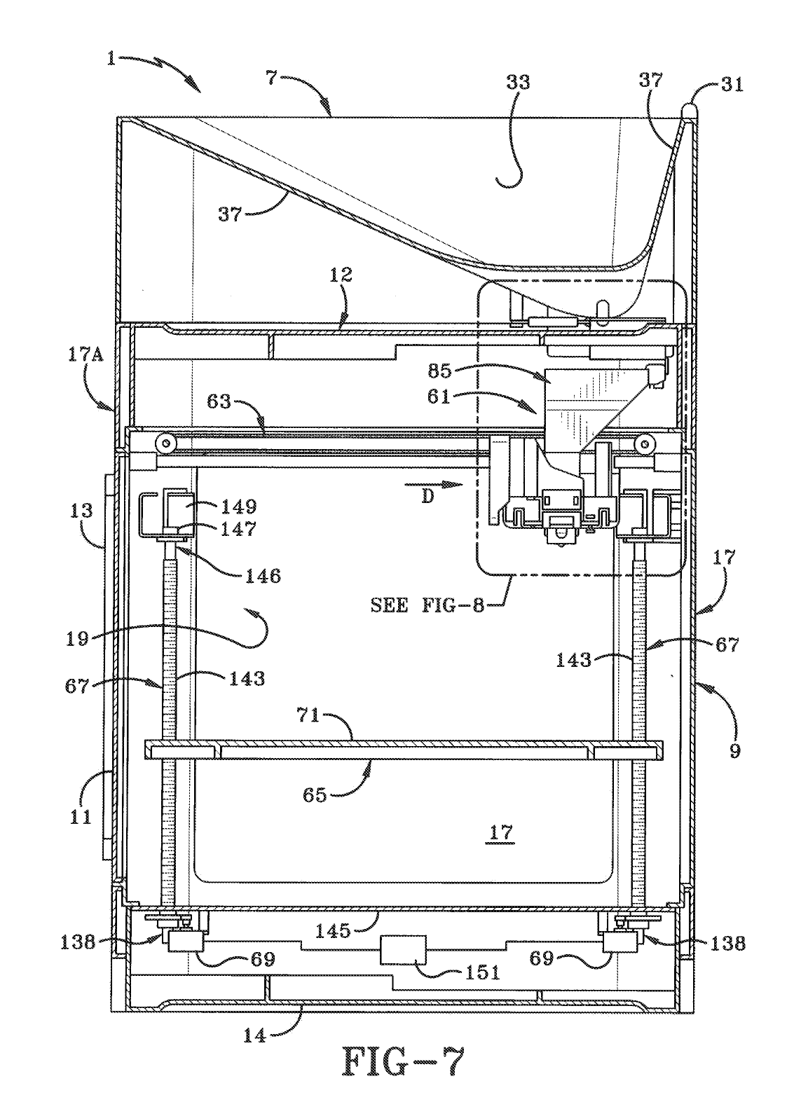

A method and apparatus for feeding print material is shown in FIGS. 1-11 and referred to generally herein as printer 1. Various non-novel features found in the prior art relating to three-dimensional or additive printing are not discussed herein. The reader will readily understand the fundamentals of printing are well within the prior art and readily understood by one familiar therewith.

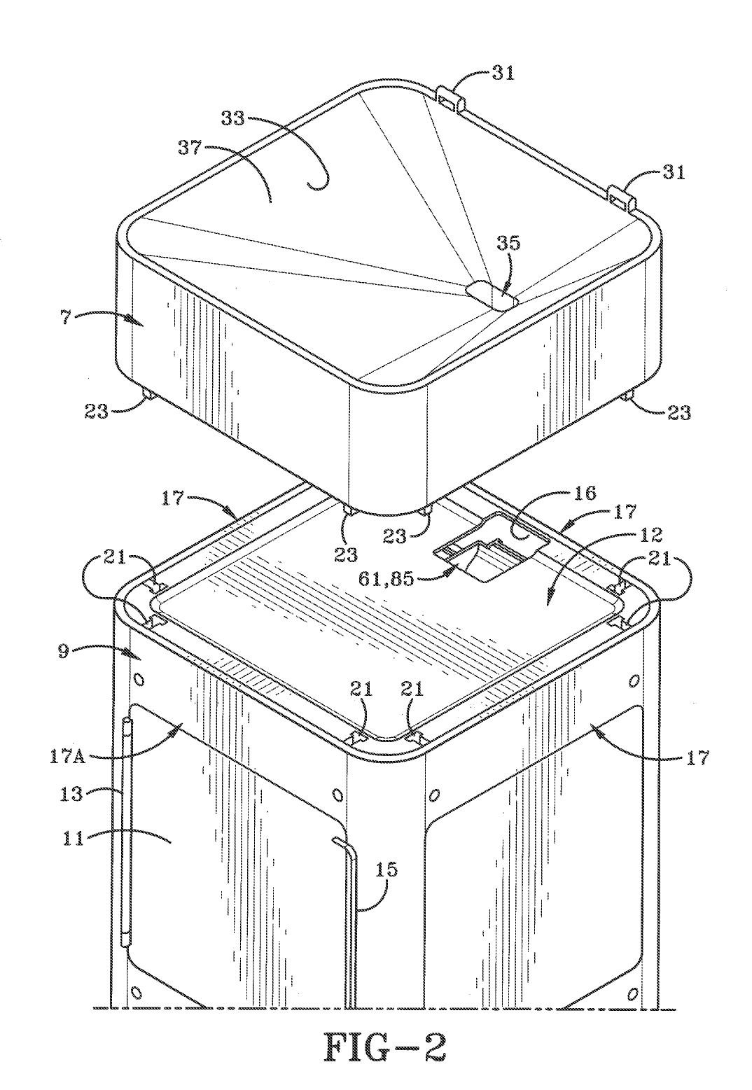

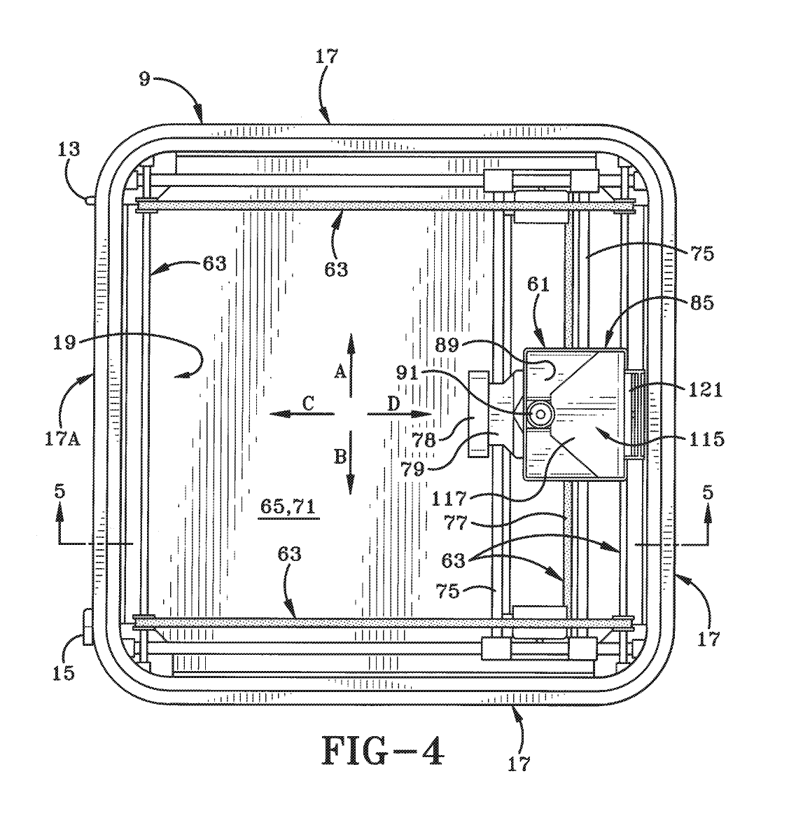

As shown in FIGS. 1, 2, and 4, printer 1 extends from a top area 3 to a bottom area 5 and is generally formed in an overall “box-like” shape. Printer 1 includes a first hopper 7, hereinafter referred to as large hopper 7, which is releasably connected with a base 9. Base 9 includes a top wall 12 (FIG. 2), a bottom wall 14 (FIG. 4), and four sidewalls 17 extending therebetween, with one sidewall 17A having a door 11 pivotable about a hinge 13 via a handle 15. Door 11 exposes an interior chamber 19 (FIG. 4) where an object may be printed by printer 1. As shown in FIG. 2, top wall 12 defines a plurality of recesses 21 sized to receive a matching plurality of projections 23 extending from large hopper 7. Top wall 12 further defines an aperture 16 opening to interior chamber 19.

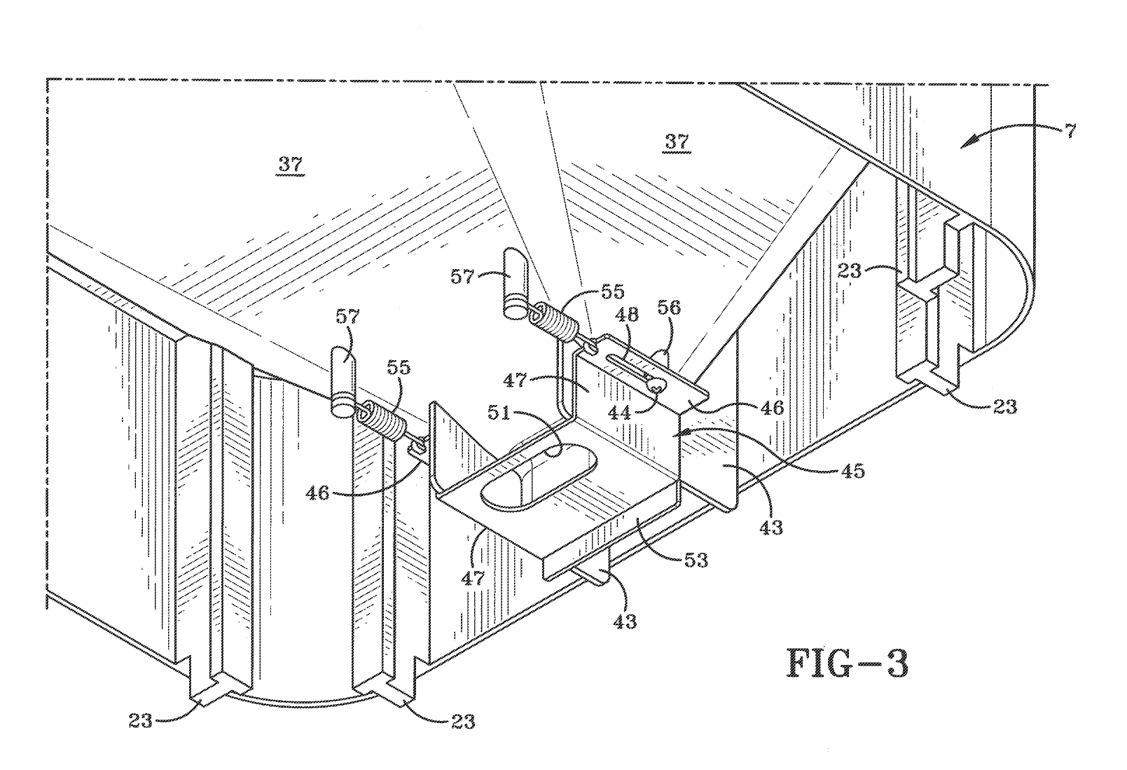

As shown in FIGS. 1-3, large hopper 7 is sized to complementarily and abuttably fit with base 9 and thus includes the same general cross-sectional shape as base 9. Large hopper 7 extends from a first end 25 to a second end 27. Proximate first end 25, large hopper 7 includes a lid 29 attached thereto by a pair of hinges 31. Lid 29 movably covers and uncovers a chamber 33 and a channel 35, both defined by a sloping wall 37. Channel 35 extends from a first end 39 generally disposed in chamber 33 to a second end 41 generally disposed between a pair of brace walls 43. As shown in FIG. 3, brace walls 43 are sized to receive a slider 45 having a pair of vertical walls 47 and a horizontal wall 49 extending therebetween. The pair of vertical walls 47 slidably abut the pair of brace walls 43 and slide thereupon. Extending outwardly from each vertical wall 47 is a slider fin 46 defining a slot 48 therein. A screw 44 extends through slot 48 and is received in a post 56 extending from sidewall 37. Slot 48 is oriented to allow slider 45 to slide about screw 44, with slot 48 acting as a track for slider 45 to move against.

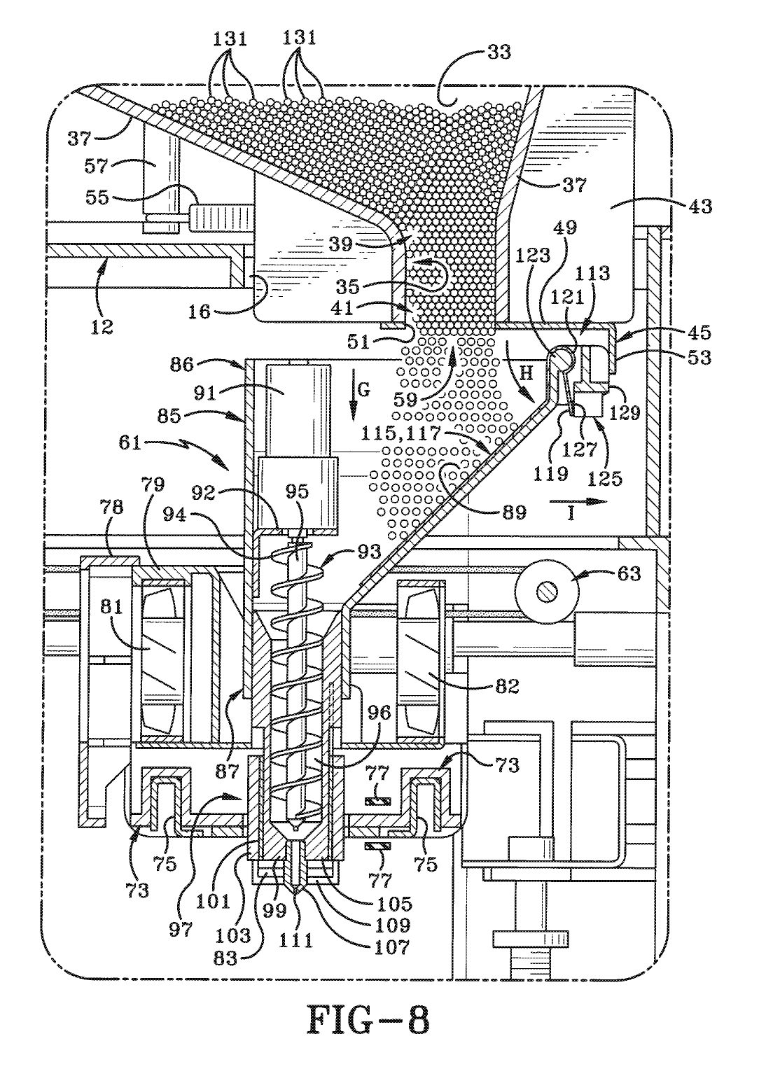

Horizontal wall 49 defines an aperture 51 sized to generally match the cross-sectional shape of channel 35 (FIG. 8). Slider further includes cam plate 53 extending outwardly away from horizontal wall 49. A pair of springs 55 are connected at one end to slider 45 and at the other end to a corresponding peg 57 extending outwardly away from the underside of wall 37. While shown in FIG. 3 as extending from wall 37, pegs 57 may be connected or positioned in any way convenient for providing stable tension on springs 55.

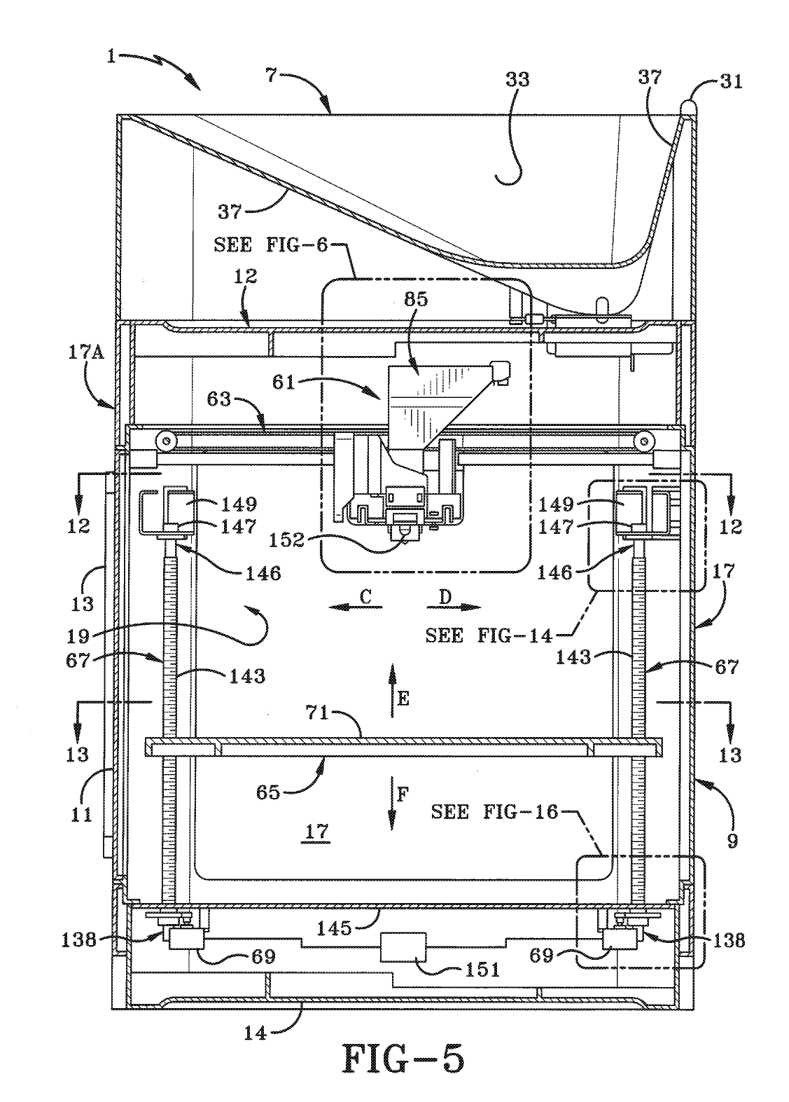

As shown in FIG. 5, slider 45 is configured to extend through aperture 16 when large hopper 7 is connected to base 9. Slider is further configured to slide between an open position (FIG. 8) and a closed position (FIG. 3). Slider 45 is biased to the closed position and in the direction of pegs 57 by way of springs 55. Slider 45 is prevented from sliding beyond the closed position in the direction of pegs 57 by way of slot 48 terminating and preventing further movement in the direction of pegs 37. Slider 45 moves from the closed position to the open position when cam plate 53 receives sufficient pressure to overcome the bias of springs 55. In the open position, aperture 51 aligns with second end 41 of channel 35 to create a channel 59 (FIG. 8). Channel 59 extends from chamber 33 through channel 35 and through aperture 51 and establishes fluid communication between chamber 33 and interior chamber 19. Channel 59 does not exist when slider 45 is in the closed position, as horizontal wall 49 moves to close channel 59 and terminate fluid communication between chamber 33 and interior chamber 19.

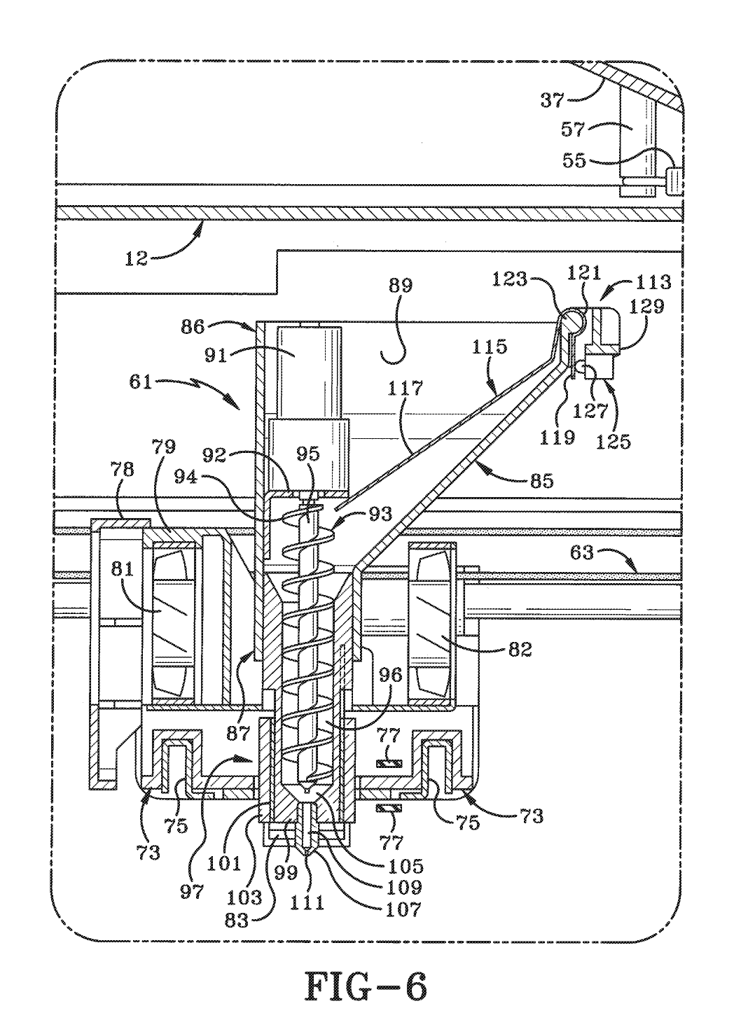

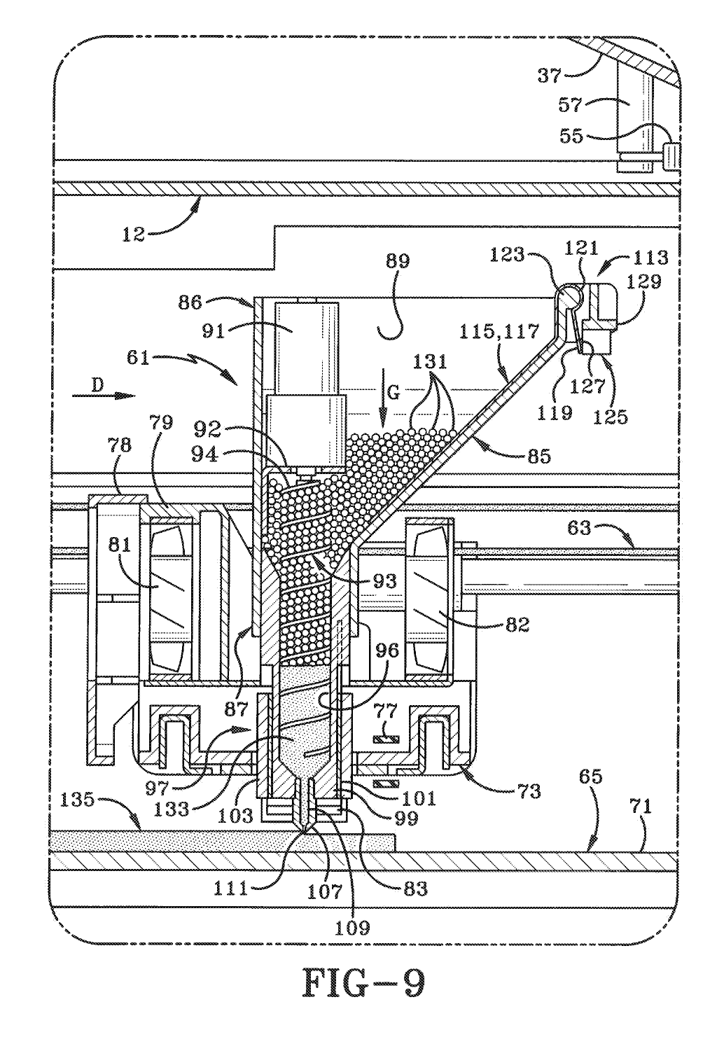

As shown in FIGS. 5 and 6, printer 1 further includes a printer assembly 61 disposed in chamber 19 and movable about an X-axis and a Y-axis therein in the directions of Arrows A, B, C, and D of FIG. 4. This movement is accomplished by way of a pulley assembly 63. Printer assembly 61 and pulley assembly 63 are configured to work in conjunction with a plate 65, which may be referred to as a printing platform. Plate 65 is movable about a Z-axis in the directions of Arrows E and F of FIG. 5. Plate 65 is movable about the Z-axis by way of threaded rods 67 turned by motors 69 to move plate 65 up and down by way of the threads on rods 67. Printer assembly 61, pulley assembly 63, and plate 65 are all inner-connected by way of circuitry and logic controlled by a processor (not shown). The processor and logic are configured to move plate 65 in the Z-axis and move printer assembly 61 in the X-axis and Y-axis to additively print an object 135 onto a top surface 71 of plate 65, as shown in FIG. 9.

As shown in FIG. 6, printer assembly 61 includes a carriage 73 which rests on a pair of rails 75 and is coupled to a looped belt 77, which is driven by the pulley assembly 63. Printer assembly 61 further includes an inlet grill 78 proximate a baffle 79 resting on carriage 73, sized to house a fan 81 and permit the flow of air therethrough. Baffle 79 is coupled with a blower element 83 which is configured to direct air from fan 81 through printer assembly 61 in a particular direction to cool a printed object. Printer assembly 61 also includes a fan 82 coupled with baffle 79 and configured to direct air through printer assembly 61 to cool the parts therein.

Printer assembly 61 further includes a second hopper 85, hereinafter referred to as small hopper 85, having a first end 86 and a second end 87. Small hopper 85 defines an opening 89 proximate first end 86 and tapers towards second end 87. A motor 91 is disposed inside small hopper 85 and connected thereto by a support flange 92. Motor 91 is connected to an auger 93 having an auger flight 94 traversing a shaft 95. Motor 91 rotates shaft 95 which in turn rotates flight 94. Auger 93 is partially disposed in a melt chamber 96 defined by a heating assembly 97. Heating assembly 97 includes a first heating element 99 partially surrounded by a second heating element 101. Second heating element 101 is partially surrounded by a thermal coupling barrel 103 for use in sensing the surface temperature of second heating element 101. First heating element 99 defines a tapered section 105 of melt chamber 96 which tapers to a nozzle 107. Melt chamber 96 terminates at nozzle 107, which defines a channel 109 therein. Channel 109 extends through nozzle 107 from melt chamber 96 to an aperture 111 defined by nozzle 107. Aperture 111 acts as the opening of channel 109.

As shown in FIG. 6, printer assembly 61 further includes a sensor assembly 113. Sensor assembly 113 includes a level indicator 115 having a first portion 117, a second portion 119, and an arcuate pivot portion 121 disposed therebetween. First portion 117 is sized to extend into small hopper 85. Pivot portion 121 is sized to pivot about an arcuate flange 123 of small hopper 85. Second portion 119 is sized and positioned to actuate a sensor 125 by pressing a plunger switch 127 thereof when level indicator 115 is in a particular position. Sensor 125 is secured to a bracket 129 of printer assembly 61.

Printer 1 is configured to be used with a plurality of pellets 131 (FIG. 8). Pellets 131 may be of any type of meltable, printable, and/or extrudable plastic or other type of material. This material is formed into pellets and used by printer 1 to form the extruded print material on demand and as needed. Pellets 131 may be injection molding pellets commonly used in injection molding systems and available commercially from injection molding equipment vendors. Injection molding pellets are readily available “off-the-shelf” and are typically priced approximately one tenth the price of three dimensional printer filament spools. Further, injection molding pellets are typically available in a variety of colors, sizes, and chemical composition. As such, a user of printer 1 may customize each print job with a different plurality of pellets in printer 1 which best suit the structural and aesthetic needs of the prospective objected to be printed.

Printer assembly 61 is configured to receive pellets 131 into small hopper 85 from large hopper 7 in the direction of Arrows G, as shown in FIG. 8. Pellets 131 enter small hopper 85 via first end 86 and opening 89 and abut and surround auger 93. As shown in FIG. 9, pellets 131 are driven downwardly towards tapered section 105 via auger flights 94 as auger 93 is turned by motor 91. The turning motion of auger 93 moves pellets 131 downwardly along and through heating assembly 97. During printing, heating assembly 97 is actuated to provide heat to melt chamber 96 which is transferred into pellets 131. More particularly, second heating element 101 receives an electrical current heating it and increasing thermal energy which is transferred into first heating element 99. First heating element 99 is configured to heat up evenly and transfers this thermal energy into pellets 131 as they move through melt chamber 96. This results in a melting of pellets 131 into a molten material 133 (FIG. 9). Thermocoupling barrel 133 reads the surface temperature of second heating element 101 and provides this information to the overall controlling unit for processor used in printer 1. This feedback is used to determine when to heat or cease heating of heating assembly 97. As pellets 131 melt into molten material 133, motor 91 continues to drive auger 93 to agitate pellets 131 and ensure an even and thorough heating. Auger 92 further presses both pellets 131 and molten material 133 towards nozzle 107. By the time pellets 131 reach nozzle 107, they have been melted by heating assembly 97 into molten material 133 and are in a sufficient viscosity to be printed via nozzle 107. As such, molten material 133 is expelled through channel 109 and out aperture 111 in accordance with the printing requirements.

In operation, printer 1 is initially provided free of pellets 131. A user approaches printer 1, lifts lid 29 of large hopper 7 about hinges 31 to reveal chamber 33. The user then fills chamber 33 with the plurality of pellets 131 which may have a particular color desirable to the user or may be comprised of injection molding pellets bought off-the-shelf. The user then closes lid 29 to seal chamber 33. Pellets 131 now populate chamber 33 and due to gravity tumble or slide down side wall 37 in the direction of channel 35. Pellets 131 fill channel 35, however, pellets 131 do not exit channel 35 due to the abutment of slider 45 which prevents pellets 131 from traveling beyond channel 35. At this stage, large hopper 7 is filled with pellets 131 and is in a ready state waiting for printer 1 to begin the printing process. Typically, the user will load a software program to initiate the printing process, typically by selecting menu options on a computer screen which drive the printing process of printer 1.

As shown in FIG. 6, level indicator 115 is in a first position which leaves plunger switch 127 undepressed by second portion 119. When plunger switch 127 is in the undepressed state, sensor 125 indicates to the overall software system that printer assembly 61 is in need of pellets 131. Upon such indication, printer assembly 61 is driven by pulley assembly 63 in the direction of Arrow B such that printer assembly 61 abuts cam plate 53. Printer assembly 61 moves cam plate 53 in the direction of Arrow B which slides slider 45 in the direction of Arrow B. This positions aperture 51 of horizontal wall 49 in alignment with channel 35 of large hopper 7. As shown in FIG. 8, by aligning aperture 51 with channel 35, channel 59 is formed and allows pellets 131 residing in large hopper 7 to flow through channel 35 and aperture 51 and fall into small hopper 85 of printer assembly 61 and in the direction of Arrows G. The weight of pellets 131 depresses level indicator 115, and in particular first portion 117. This moves pivot portion 121 over arcuate flange 23 and subsequently actuates second portion 119 to depress plunger switch 127 of sensor 125. The depression of plunger switch 127 initiates a software subroutine which actuates printer assembly 61 to move in the direction of Arrow A and away from cam plate 53. Inasmuch as slider 45 is spring loaded by springs 55 and biased in the direction of Arrow A, printer assembly 61 moving in the direction of Arrow A allows slider 45 to automatically move in the direction of Arrow A and close channel 59. By closing channel 59, pellets 131 may no longer exit large hopper assembly 7 and are contained therein until further need.

After small hopper 85 is sufficiently filled with pellets 131, the overall printing process of printer 1 may begin. Motor 91 is engaged to rotate auger 93 and drive pellets 131 downwardly in the direction of Arrow G. The weight of pellets 131 presses down on first portion 117 of level indicator 115 in the direction of Arrow H. This rotates pivot portion 121 about arcuate flange 123 and moves second portion 119 to depress plunger switch 127 in the direction of Arrow I. The depression of plunger switch 127 indicates to sensor 125 small hopper 85 has a sufficient amount of pellets 131 therein, as shown in FIG. 9.

As shaft 91 of auger 93 turns, auger flights 94 direct each pellet 131 downwardly through melt chamber 96. Within melt chamber 96, pellets 131 are melted by first heating element 99 and second heating element 101 and turned into molten material 133. The continuing pressure and movement of pellets 131 and molten material 133 along auger flights 94 press molten material 133 into tapered section 105 and further into nozzle 107. All the while, printer assembly 61 is moving in one or more of the X-axis, Y-axis, and Z-axis, to position nozzle 107 as desired and as required by the desired printing operation. As shown in FIG. 9, nozzle 107 extrudes or prints molten material 133 outwardly away therefrom where molten material 133 is expelled through aperture 111 to print object 135. Fan 81 blows cooling air outwardly away from blower 83 and onto object 135 to cool and solidify molten material 133 into object 135. As such, pellets 131 are formed into molten material 133 on demand and as needed by the overall printer 1 and extruded outwardly from nozzle 107 as required by the print job.

At any point during the printing process, if the plurality of pellets 131 in small hopper 85 fall below a particular pre-set threshold, level indicator 114 rises due to the removal of pressure thereupon by pellets 131. Level indicator 114 is connected with arcuate flange 123 such that when first portion 117 moves upwardly, second portion 119 presses into plunger switch 127 and depresses plunger switch 127 into sensor 125. The depression of plunger switch 127 actuates a subroutine configured to automatically acquire more pellets 131 from large hopper 7. In this scenario, printer assembly 61 moves to abut cam plate 53 and release pellets 131 from large hopper 7 in the same manner as discussed above with respect to the initial receipt of pellets 131. In this manner, printer 1 may print continuously and without any need for human intervention to ensure printer 1 is supplied with pellets 131 and overall supplied with print material, referred to herein as molten material 133.

One will readily recognize that printer 1 does not include a print filament as commonly known in the art and will not experience a broken filament or a broken printing stream as the printing stream of printer 1 is fluid and dynamically replenished during the print process. Further, one will also readily recognize that printer 1 includes an automatic mechanism for refilling small hopper 85 by way of sensor assembly 113 and large hopper 7. Large hopper 7 is sufficiently sized to provide chamber 33 having enough volume to contain a large enough supply of pellets 133 for completing any size print job capable of being printed by printer 1.

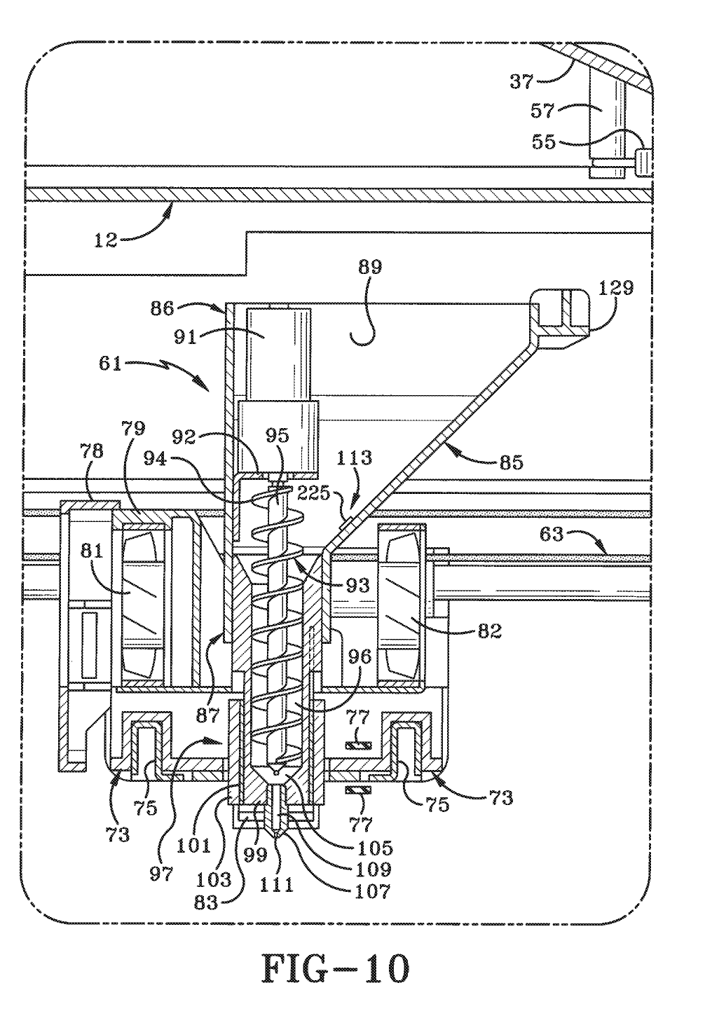

As shown in FIG. 10, sensor assembly 113 may incorporate a sensor 225 free of the plunger switch of the previous embodiment for another style of sensing device. As such, sensor 225 may be a light sensor or a pressure sensor for recognizing when pellets 131 have fallen below a particular threshold. At that time, sensor 225 alerts sensor assembly 113 whereby a software routine is actuated to automatically retrieve more pellets 131 in the methods previously discussed. Sensor 225 may alert sensor assembly 113 by way of a wireless communication link between two wireless modules. Further, sensor assembly 113 may alert the overall control unit or processor by way of a wireless communication link between two wireless modules, one residing proximate sensor assembly 113 and one residing proximate the control unit or processor. In this way, wired communication is not necessary and the tangling of communication wires as printer assembly 61 moves in the X-axis, Y-axis, and Z-axis is prevented.

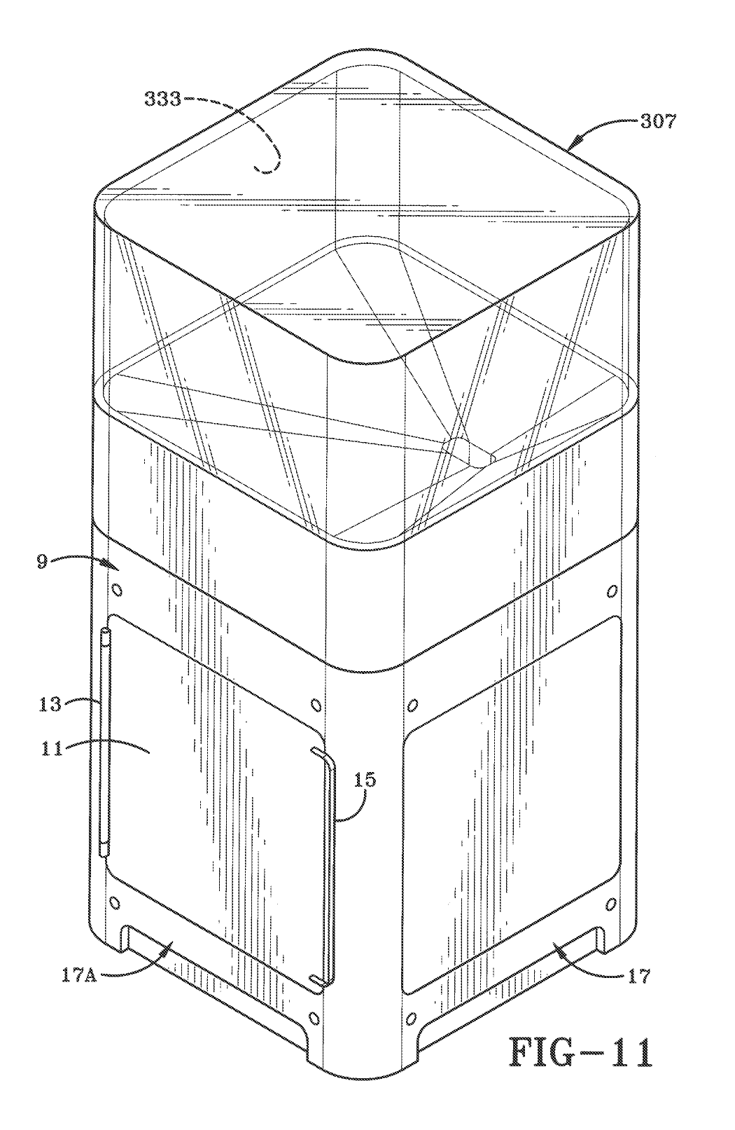

As shown in FIG. 11, large hopper 7 may be embodied by a large hopper 307 which includes a chamber 333 which is inaccessible by a user. Chamber 333 is sealed at the factory and provided or sold to a user in a sealed state for connection with base 9. As such, printer 1 may alternatively utilize large hopper 7 which is refillable by a user or large hopper 307 which is not refillable by a user. Printer 1 may be configured to receive either large hopper 7 or large hopper 307, or both.

Printer 1 may further include elements directed to automatically leveling plate 65, also known as the printing platform or as the “Z-platform”. One familiar with the art would readily recognize the need for keeping plate 65 perfectly level in the horizontal plane to facilitate accurate three-dimensional printing. Inasmuch as three-dimensional printing requires a high degree of precision in all of the X, Y, and Z plans, keeping plate 65 level is a critical task in the given environment.

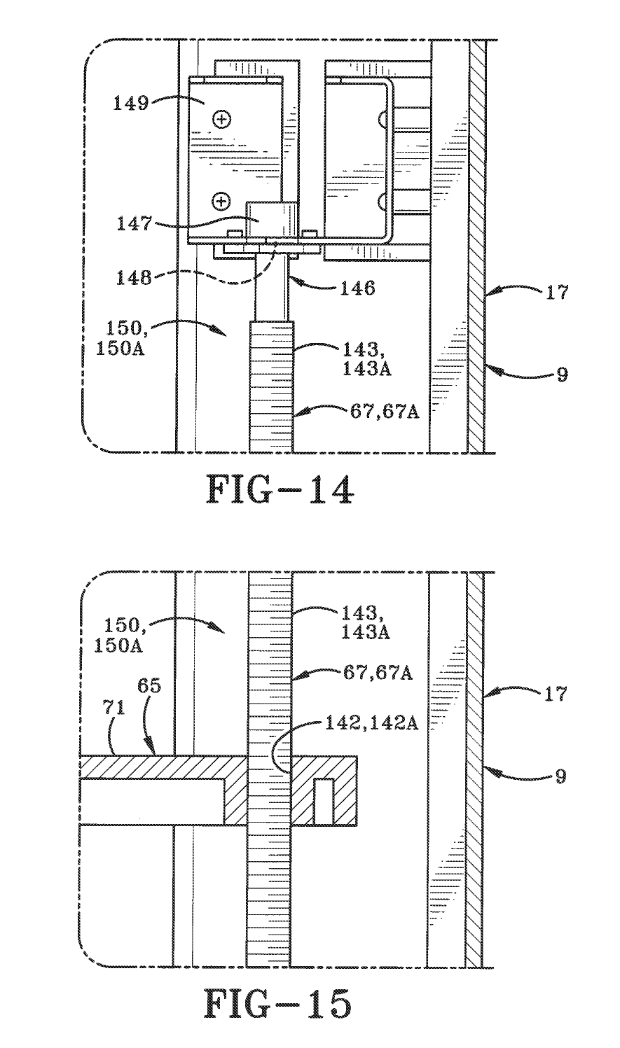

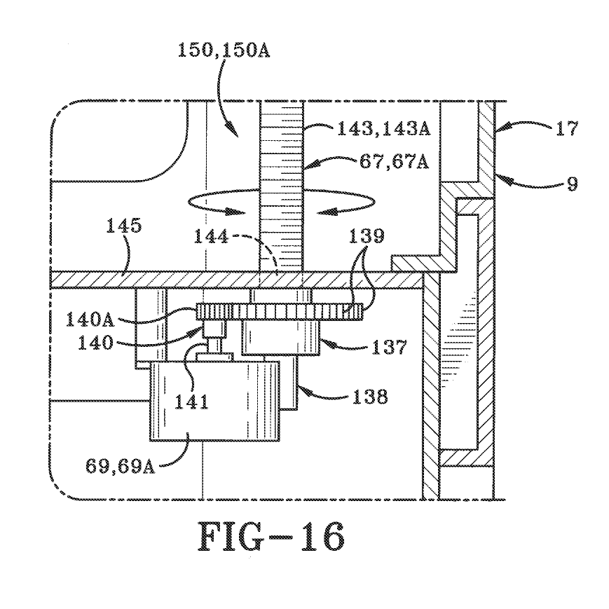

In light of the above, as shown in FIG. 16, printer 1 incorporates a drive gear 137 secured to a first end 138 of each threaded rod 67. Drive gear 137 provides a plurality of gear teeth 139 formed to cooperate with a gear 140 having plurality of gear teeth 140A disposed on a shaft 141 of motor 69. As motor 69 turns shaft 141, gear teeth 140A turn and drive gear teeth 139, which turns drive gear 137. The rotation of drive gear 137 turns the entire threaded rod 67 attached thereto. As shown in FIGS. 14 and 15, each threaded rod 67 extends through a matching threaded aperture 142 defined by plate 65. Threaded aperture 142 is sized and shaped to complement a threaded surface 143 exposed on threaded rod 67. For stability, threaded rod 67 extends through an opening 144 defined by a base plate 145 proximate first end 138 of threaded rod 67. Similarly, a second end 146 of threaded rod 67 is received in a screw cap 147, which is secured in an aperture 148 of a bracket 149. Bracket 149 is secured to sidewall 17 to hold second end 146 of threaded rod 67 firmly in place, while still allowing axial rotation of threaded rod 67.

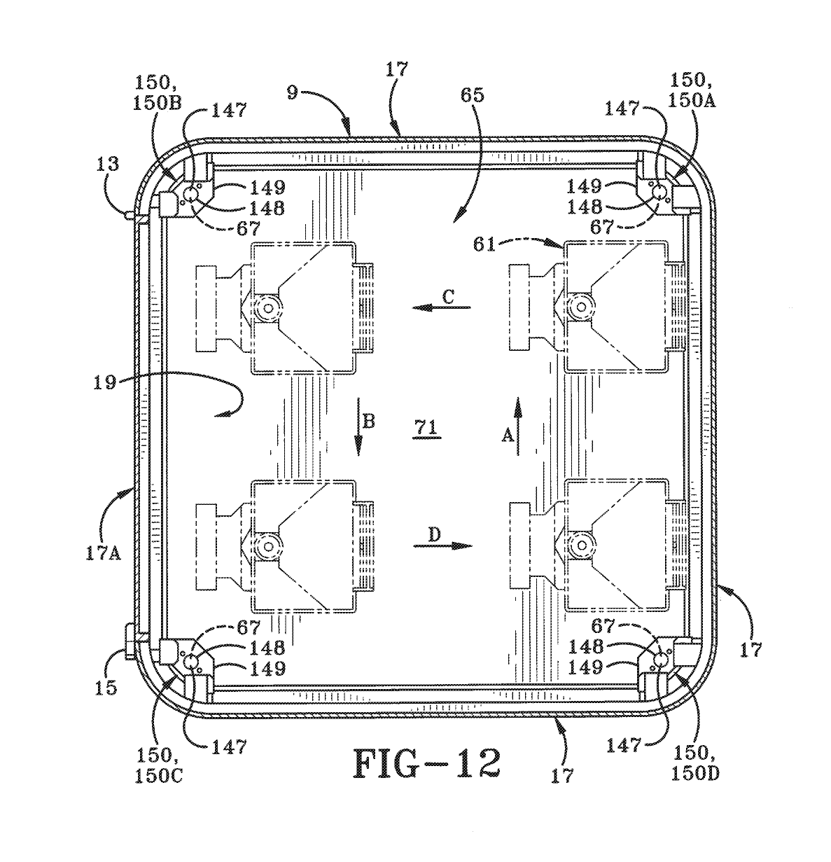

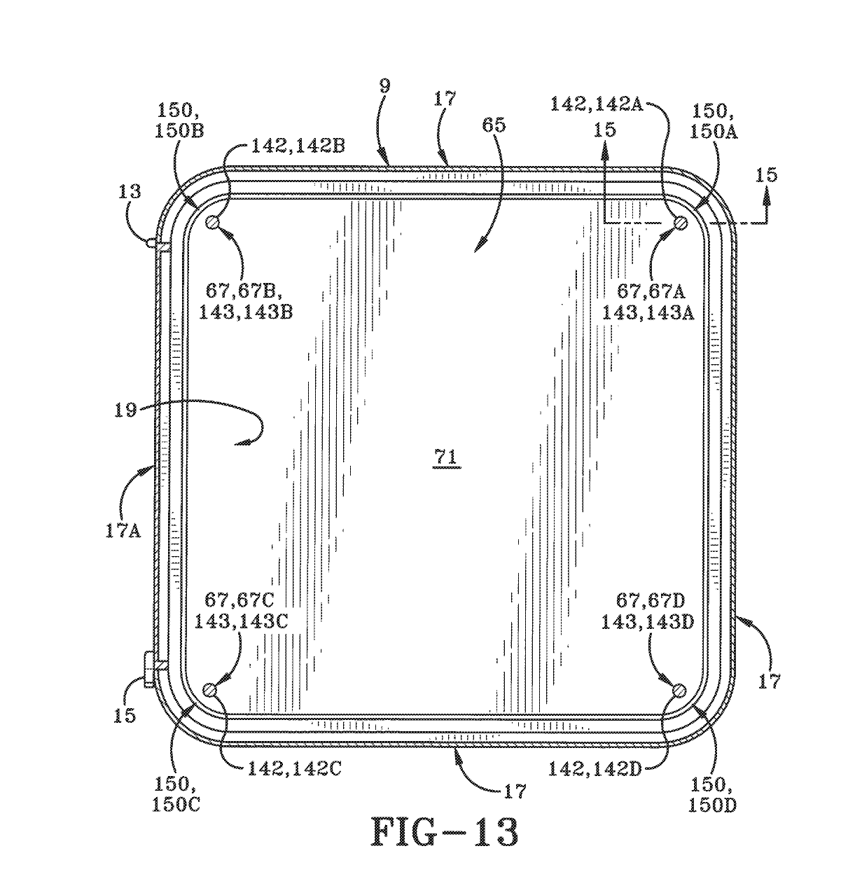

As shown in FIG. 13, plate 65 is generally rectangular and formed having four general corners 150 spaced apart with threaded rods 67 providing a plate support system 136 for supporting corners 150 of plate 65. Each corner 150 defines its own threaded aperture 142, which acts as a screw drive follower for the associated corner 150 of plate 65, as threaded aperture 142 receives one of the threaded rods 67 therein. As an individual threaded rod 67 rotates axially, for example threaded rod 67A, threaded surface 143A of threaded rod 67A rotatably abuts threaded aperture 142A of that particular corner 150, for example corner 150A. This drives corner 150A either vertically upwards or vertically downwards relative to threaded rod 67A, depending on the direction of axial rotation of rod 67A. For example, if one of the corners 150 of plate 65 is lower than the other corners 150, rod 67 is rotated the appropriate amount by its corresponding motor 69 to raise the low corner 150 into alignment with the remaining corners 150. Motor 69 rotates threaded rod 67, which moves plate 65 by way of a follower mechanism formed between threaded aperture 142 and threaded rod 67.

Rods 67 are rotated axially in a first direction and an opposite second direction by the corresponding motor 69 connected thereto. Thus, if rod 67A is rotated in the first direction by motor 69A, corresponding corner 150A moves upwardly away from motor 69A. Conversely, if motor 69A rotates rod 67A in the second direction, corner 150A moves downwardly towards motor 69A. As such, motor 69A and rod 67A work in conjunction to move corner 150A in the desired vertical direction. All other rods 67 and associated motors 69 work similarly. While a screw drive style mechanism is shown and described herein, threaded rods 67 cooperating with threaded apertures 142 may be replaced by a belt driven system, a magnetically actuated system, or any other style of moving plate 65 in a vertical direction.

Motor 69 is actuated to move the corresponding rod 67 by an electrical impulse provided in any way commonly used in the art. For example, motor 69 may be connected by a wire or wireless connection to a controller 151. Motor 69 may be embodied in a servomotor or servomotor system or another similar type of rotary actuator that allows for precise control of angular position, velocity and acceleration. Motor 69 embodied in a servomotor may consist of a suitable motor coupled to a sensor (not shown) for position feedback. A servomotor would necessarily also require a relatively sophisticated controller 151, which may employ a dedicated module (not shown) designed specifically for use with each individual motor 69 embodied in a servomotor. For clarity, motor 69 embodied as a servomotor is not a different class of motor 69, on the basis of fundamental operating principle, but motor 69 embodied as a servomotor uses a servomechanism to achieve closed loop control with a generic open loop motor. A servomechanism, sometimes shortened to servo, is an automatic device that uses error-sensing negative feedback to correct the performance of a mechanism and is defined by its function. As such, motor 69 embodied in a servomotor may include an encoder for providing the error-sensing negative feedback or a similar feedback or error correction. Broadly, motor 69 may be embodied in a system where the feedback or error-correction signals help control mechanical position, speed or other parameters of the rotary actuator. This allows a finely tuned control of the vertical positioning of plate 65.

Alternatively, motor 69 may be embodied in a stepper motor or stepper motor system. Stepper motors typically include an indexer or controller, which may be a microprocessor capable of generating step pulses and direction signals for a driver. The driver amplifies or converts the indexer's command signals into the power necessary to energize a set of motor windings (not shown). The driver actuates stepper motors, which are electromagnetic devices that convert digital pulses into mechanical shaft rotation to rotate shaft 141 (FIG. 16). Motor 69 embodied as a stepper motor gains the advantages of low cost, high reliability, high torque at low speeds and a simple, rugged construction that operates in almost any environment.

Controller 151 coordinates and manages each motor 69 and may perform the necessary calculations for determining how to level plate 65. Controller 151 may be a micro-controller, microchip, or a central processing unit which provides the necessary electric current or signals for actuating motor 69 to turn in the desired direction for the desired time. Controller 151 may perform the calculations to determine the desired turn direction and turn duration of motor 69, or controller 151 may receive those variables from another source such as a central processing unit and convert these variables into an electrical current and apply the current to motor 69.

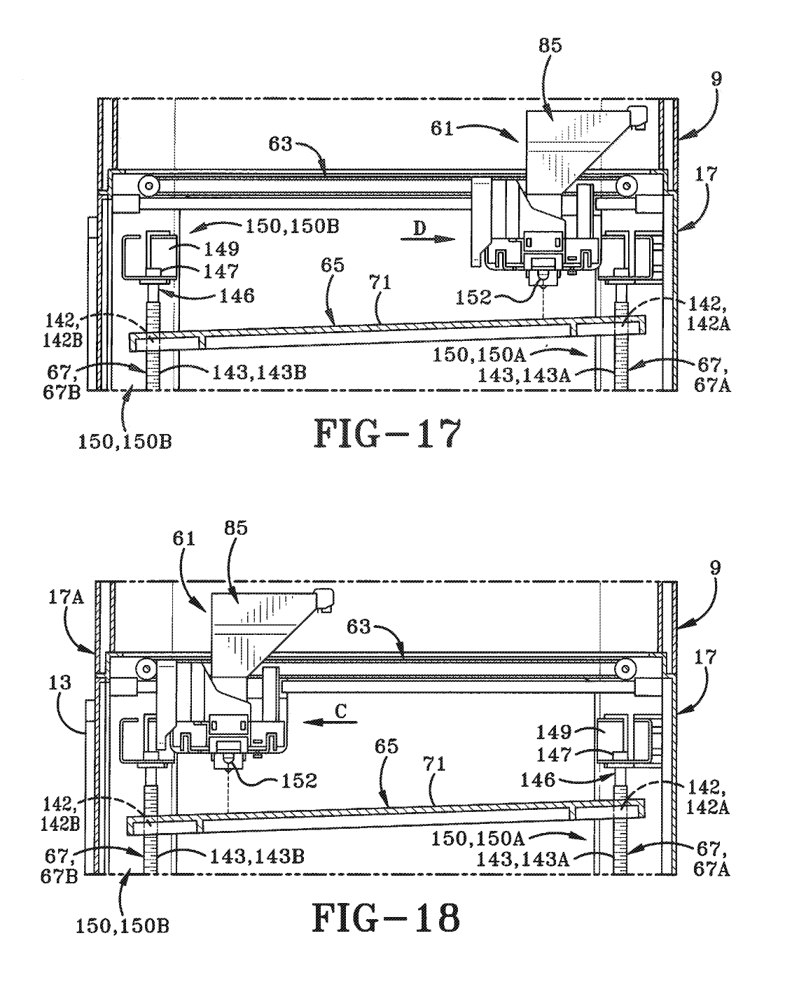

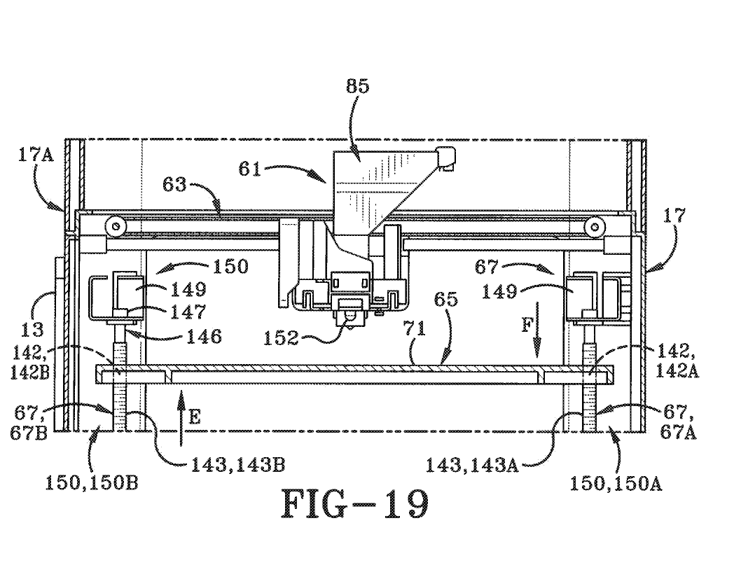

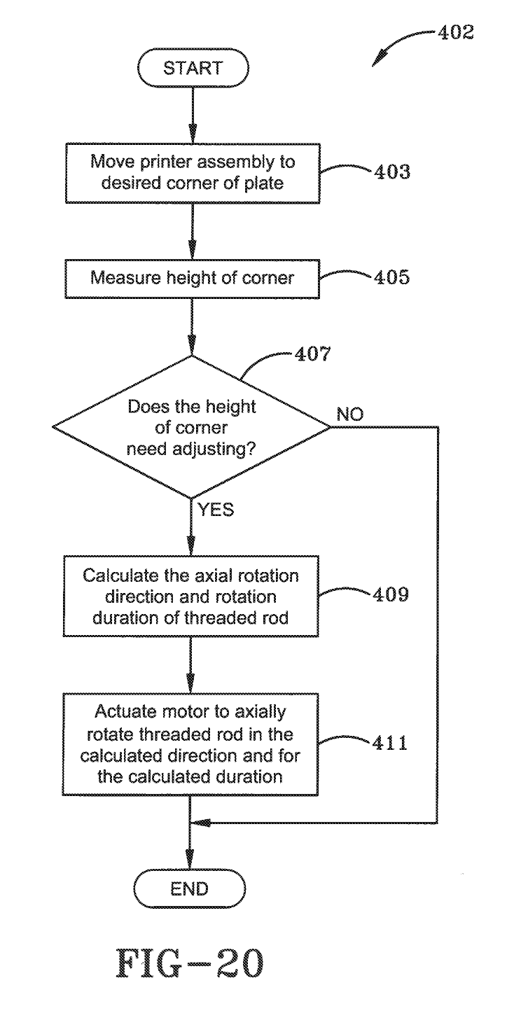

As shown in FIGS. 17-19, a sensor 152 may be incorporated into printer assembly 61. Sensor 152 may be mechanical such as an elongated whisker or dipstick style of mechanical height sensor. Alternatively, sensor 152 may be embodied in a non-mechanical non-contact style of sensor such as an ultrasonic wave emitter/receiver or a laser beam emitting apparatus. As shown in FIG. 17, sensor 152 is embodied in an ultrasonic sensor 152 which emits short bursts of ultrasonic energy. After each burst, sensor 152 listens for a return signal within a small window of time and calculates the distance between sensor 152 and the area of plate 65 directly vertically below printer assembly 61. As shown in FIGS. 12, 17, and 18, inasmuch as printer assembly 61 is movable about the X-Y plane within printer 1, printer assembly 61 may move and take height measurements of the different areas of plate 65 and determine if any section is not in height conformance with the other sections, indicating plate 65 is not horizontally level.

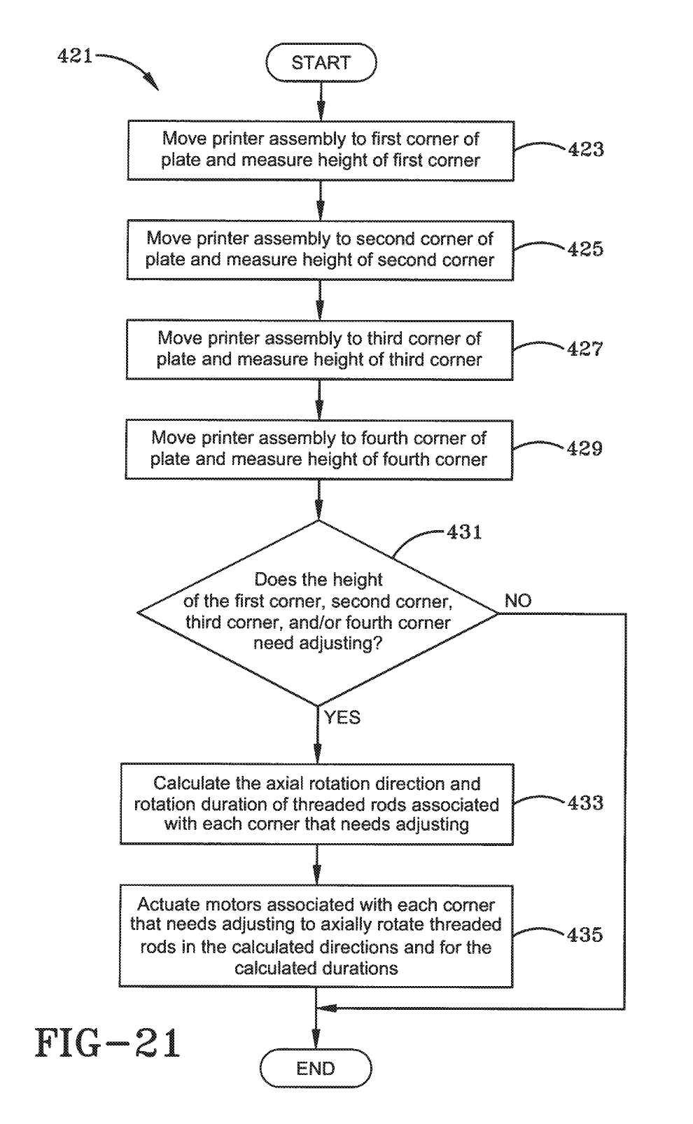

As shown in FIG. 20, printer 1 may utilize a method 402. In method 402, sensor 152 is used to adjust a corner of plate 65. Method 402 may be used iteratively with each of the four corners 150 to align the entire plate 65 and ensure plate 65 is level in the horizontal plane. Method 402 starts with a step 403, where printer assembly 61 is moved to a desired corner 150 of plate 65, for example, corner 150A. Step 403 then moves to a step 405, where sensor 152 measures the height of corner 150A. Step 405 then moves to a step 407, where a decisions is made as to whether the height of corner 150A needs adjusting. If it is determined that the height of corner 150A does need adjusting, step 407 proceeds to a step 409. Alternatively, if it is determined that the height of corner 150A does not need adjusting, step 407 proceeds to end method 402. Step 409 calculates the axial rotation direction and the rotation duration of threaded rod 67A. For example, if corner 150A needs adjusted in the upward direction, the axial rotation of rod 67A which corresponds to moving corner 150A in the upward direction is determined. In addition, the particular duration for rotating rod 67A is also calculated. After these two variables are calculated, step 409 moves to a step 411. In step 411, motor 69A is actuated to rotate threaded rod 67A in the calculated axial direction and for the calculated duration. This adjusts the height of corner 150A to the desired level. Thereafter, step 411 moves to end method 402. One will readily recognize that method 402 may be used iteratively with each corner 150 to adjust the level of each corner 150 and thereby affect the overall level of plate 65.

As shown in FIG. 21, printer 1 may utilize a method 421. Similar to method 402, method 421 also uses sensor 152 to adjust plate 65. However, in contrast to method 402, method 421 measures the height of each corner 150 first and thereafter calculates the relative changes in height with respect to each corner 150. Method 421 starts and proceeds to a step 423 where printer assembly 61 moves to a first corner 150A of plate 65 and measures the height of first corner 150A using sensor 152. Step 423 thereafter proceeds to a step 425. In step 425, printer assembly 61 moves to a second corner 150B of plate 65 and measures the height of second corner 150B using sensor 152. Step 425 thereafter proceeds to a step 427. In step 427, printer assembly 61 moves to a third corner 150C of plate 65 and measures the height of third corner 150B using sensor 152. Step 427 thereafter proceeds to a step 429. In step 429, printer assembly 61 moves to a fourth corner 150D of plate 65 and measures the height of fourth corner 150D using sensor 152. Step 429 thereafter proceeds to a step 431. In step 431, a determination is made as to whether any of the corners 150A, 150B, 150C, and/or 150D need adjusting. This logic is implemented to calculate offsets height adjustments from each corner 150 relative to one another to make plate 65 horizontally level. These adjustments may include lowering a particular corner 150 while simultaneously raising another corner 150. If step 431 determines that any of the corners 150 need adjusting, step 431 moves to a step 433. If step 431 determines that plate 65 is level and no corners need adjusting, step 431 moves to end method 421. In step 433, the axial rotational directions and durations for each corner 150 that needs adjusted is calculated. Thereafter, step 433 moves to a step 435. In step 435, each motor 69 associated with a corner 150 that needs adjusted is actuated to move in the calculated axial rotational direction and for the calculated duration. Each motor 69 may be actuated at the same time to provide for a simultaneous and efficient overall adjustment of plate 65. Thereafter, step 435 proceeds to end method 421.

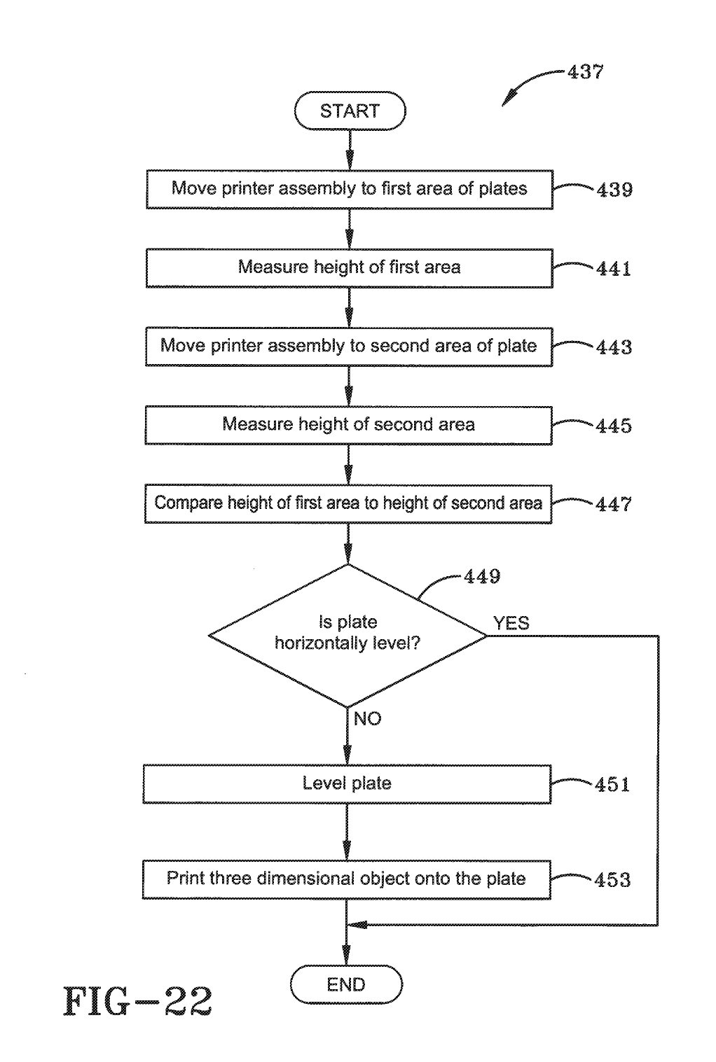

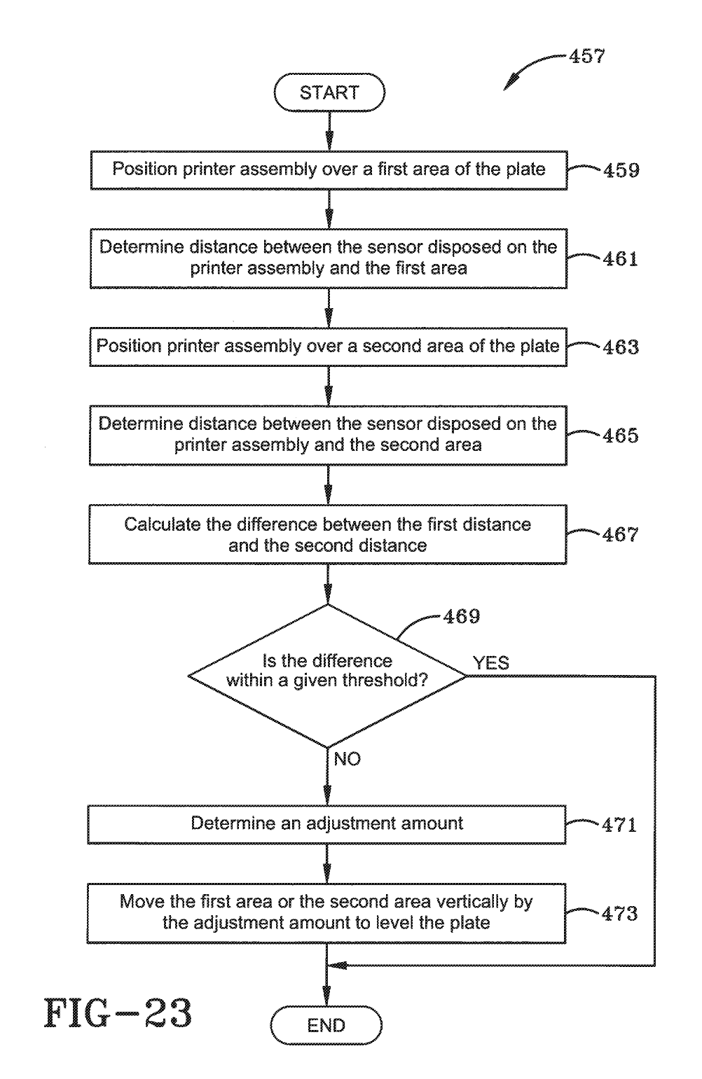

As shown in FIG. 22, printer 1 may utilize a method 437 for leveling plate 65. Method 437 starts and moves to a step 439, where the printer assembly is moved to a first area of the plate. Step 439 then moves to a step 441. In step 441, the height of the first area is measured. Step 441 then moves to a step 443. In step 443, the printer assembly is moved to a second area of the plate. Step 443 then moves to a step 445. In step 445, the height of the second area is measured. Step 445 then moves to a step 447. In step 447, the height of the first area is compared to the height of the second area. Step 447 then moves to a step 449. Step 449 determines whether the plate is horizontally level based on the heights of the first are and the height of the second area. If step 449 determines that the plate is horizontally level, step 449 moves to a step 453. Alternatively, if step 449 determines that the plate is not horizontally level, step 449 moves to a step 451. Step 451 levels the plate and moves to step 453. In step 453, the printer assembly prints the three dimensional object on the horizontally level plate. Step 453 then moves to end method 437.

As shown in FIG. 23, printer 1 may utilize a method 457 for leveling plate 65. Method 457 starts and moves to a step 459. Step 459 positions the printer assembly over a first area of the plate and moves to a step 461. Step 461 determines the distance between a sensor disposed on the printer assembly and the first area and moves to a step 463. Step 463 positions the printer assembly over a second area of the plate and moves to a step 465. Step 465 determines the distance between the sensor and the second area and moves to a step 467. Step 467 calculates the difference between the first distance and the second distance and moves to a step 469. Step 469 determines whether the difference is within a given threshold. If step 469 determines the difference is within the given threshold, step 469 proceeds to end method 457. Alternatively, if step 469 determines the difference is not within the given threshold, step 469 proceeds to a step 471. Step 471 determines an adjustment amount and moves to a step 473. Step 473 moves either the first area or the second area vertically by the adjustment amount to level the plate. Step 473 thereafter proceeds to end method 457.

“Logic,” “logic circuitry,” or “logic circuit,” as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

In the foregoing description, certain terms have been used for brevity, clearness, and understanding. No unnecessary limitations are to be implied therefrom beyond the requirement of the prior art because such terms are used for descriptive purposes and are intended to be broadly construed.

While the present invention has been described in connection with the preferred embodiments of the various figures, it is to be understood that other similar embodiments may be used or modifications and additions may be made to the described embodiment for performing the same function of the present invention without deviating there from. Therefore, the present invention should not be limited to any single embodiment, but rather construed in breadth and scope in accordance with the recitation of the appended claims.

1. A method of three dimensional printing adapted to print a three dimensional object, the method comprising the steps of:
moving a printer assembly to a first area of a vertically adjustable plate;
measuring a first height of the first area using the printer assembly;
moving a printer assembly to a second area of the vertically adjustable plate;
measuring a second height of the second area using the printer assembly;
determining whether the plate is horizontally level by comparing the first height and the second height;
leveling the plate if the plate is not horizontally level; and
printing the three dimensional object onto the plate.

2. The method of claim 1, further comprising the step of adjusting vertically one of the first area and the second area to make the plate horizontally level.

3. The method of claim 2, further comprising the step of actuating a motor to adjust vertically the one of the first area and the second area.

4. The method of claim 3, further comprising the step of rotating a threaded rod by way of the motor to adjust vertically the one of the first area and the second area.

5. The method of claim 4, further comprising the step of measuring the first height and the second height by one of an ultrasonic energy burst and a laser beam.

6. The method of claim 4, further comprising the step of measuring the first height and the second height by a mechanical height sensor.

7. The method of claim 1, further comprising the steps of:
moving a printer assembly to a third area of a vertically adjustable plate;
measuring a third height of the third area using the printer assembly;
moving a printer assembly to a fourth area of the vertically adjustable plate;
measuring a fourth height of the fourth area using the printer assembly; and
determining whether the plate is horizontally level by comparing the first height, the second height, the third height, and the fourth height.

8. The method of claim 7, further comprising the steps of:
forming the plate in a general rectangular shape with a set of four corners;
locating the first area in a first corner of the set of four corners;
locating the second area in a second corner of the set of four corners;
locating the third area in a third corner of the set of four corners; and
locating the fourth area in a fourth corner of the set of four corners.

9. The method of claim 1, further comprising the steps of:
heating a plurality of pellets in a small hopper of the printer assembly;
melting the plurality of pellets to form a molten material; and
printing the three dimensional object onto the plate with the molten material.

10. The method of claim 1, further comprising the steps of:
calculating a difference between the first height and the second height;
determining whether the difference is within a threshold; and
determining the plate is horizontally level when the difference is within the threshold.

11. An apparatus adapted to print a three dimensional object, the apparatus comprising:
a printer assembly movable in a plane;
a sensor disposed on the printer assembly and movable therewith;
a plate having a surface and movable between a level position and an unlevel position, wherein the surface is parallel with the plane when the plate is in the level position, and wherein the surface is not parallel with the plane when the plate is in the unlevel position;
a control system, wherein the control system is adapted to move the printer assembly to print the three dimensional object, and wherein the control system is adapted to move the plate from the unlevel position to the level position; and
wherein the sensor is configured to determine whether the plate is in the unlevel position and actuate the control system to move the plate to the level position when the plate is in the unlevel position.

12. The apparatus of claim 11, wherein the sensor emits bursts of ultrasonic energy to determine whether the plate is in the unlevel position.

13. The apparatus of claim 11, wherein the sensor emits a laser to determine when the plate is in the unlevel position.

14. The apparatus of claim 11, wherein the control system actuates a plurality of motors to move the plate from the unlevel position to the level position.

15. The apparatus of claim 14, further comprising:
a first threaded rod extending from a first motor through the plate;
a second threaded rod extending from a second motor through the plate;
wherein the control system selectively actuates one or both of the first motor and the second motor to axially rotate the associated first threaded rod and second threaded rod to move the plate from the unlevel position to the level position.

16. The apparatus of claim 14, further comprising:
a plate support system for supporting a set of four corner areas of the plate, wherein the plate support system includes a set of four threaded rods, each rod extending from a first end to a second end and through a unique corner area in the set of four corner areas of the plate; and
wherein each rod is individually axially rotatable to move the associated corner area of the plate.

17. The apparatus of claim 16, wherein the control system actuates each rod individually to move the corner area associated with the rod and thereby move the plate from the unlevel position to the level position.

18. A method of printing a three dimensional object, the method comprising the steps of:
positioning a printer assembly over a first area of the plate;
determining a first distance between a sensor disposed on the printer assembly and the first area;
positioning the printer assembly over a second area of the plate;
determining a second distance between the sensor and the second area;
calculating a difference between the first distance and the second distance;
determining whether the difference is within a threshold;
determining an adjustment amount if the difference is not within the threshold;
moving one of the first area and the second area vertically by the adjustment amount to level the plate if the difference is not within the threshold;
receiving a plurality of pellets into a hopper of the printer assembly;
melting the plurality of pellets in the printer assembly to form a printing filament; and
expelling the printing filament onto the plate to form the three dimensional object.

19. The method of claim 18, further comprising the step of axially rotating a rod to move one of the first area and the second area vertically.

20. The method of claim 18, further comprising the step of emitting one of an ultrasonic energy burst and a laser beam to determine the first distance and the second distance.
